(19) United States
(12) Patent Application Publication
(10) Pub. No.: US 2022/0031062 A1
(43) Pub. Date: Feb. 3, 2022

(54) LIFTING COLUMN AND DRIVE SYSTEM FOR A LIFTING SYSTEM OF A FURNITURE

(71) Applicant: Kesseböhmer Holding KG, Bad Essen (DE)

(72) Inventors: Marcus ALBERT, Neidlingen (DE); Julian KLOTZ, Beuren (DE); Andreas NONNENMACHER, Albershausen (DE); René BARKAU, Ostercappeln (DE)

(73) Assignee: Kesseböhmer Holding KG, Bad Essen (DE)

(21) Appl. No.: 17/378,709

(22) Filed: Jul. 18, 2021

(30) Foreign Application Priority Data
Jul. 30, 2020 (DE) 10 2020 209 631.7

(51) Int. Cl. A47B 9/20; B66F 3/44; B66F 3/46

(52) U.S. Cl. CPC A47B 9/20; B66F 3/44; A47B 2200/0062; A47B 2200/0056; A47B 2200/0051; B66F 3/46

(57) ABSTRACT

A lifting column (3) for a lifting system (2) of a furniture is provided. The lifting column (3) comprises at least two tube portions (4, 5) displaceable with respect to one another like a telescope, a high-voltage direct-current motor (6) and a transmission (7) for transforming a rotational motion into a linear motion, wherein the high-voltage direct-current motor (6) and the transmission (7) are arranged inside at least one of the at least two tube portions (4, 5) displaceable with respect to one another like a telescope.

### RELATED APPLICATION

This application claims the benefit of priority of German Patent Application No. 10 2020 209 631.7 filed on Jul. 30, 2020, the contents of which are incorporated herein by reference in their entirety.

### FIELD AND BACKGROUND OF THE INVENTION

The invention relates to a lifting column and a drive system for a lifting system of a furniture, in particular, a lifting column and a drive system for a motorized height adjustment of a component of a furniture.

In the state of the art, lifting columns and drive systems for furniture, for example, for tabletops of tables, are known. These lifting columns are driven by electric motors operated by means of a low voltage lower than 50 V.

However, a utilization of such a voltage has the disadvantage that a power supply unit, having a transformer, transforming a line voltage of the supply network into the low voltage and rectifying the line voltage is necessary. Thereby, there is the problem that the transformer has to be dimensioned in the appropriate manner. Dimensioning to a too low power causes that, e.g., the tabletop with a specific load cannot be lifted at a desired velocity. Upon dimensioning to a too large power, the costs for the transformers and, also, an anyway relatively large space requirement of the transformer are increased.

When the motors are installed in the lifting columns, there is moreover a space problem since, as the case may be, the dimensions of the lifting columns have to be enlarged due to the size of the motor.

The object underlying the invention is to remedy the above disadvantages and to provide a lifting column and a drive system for a lifting system having at least similar power values with a lower space requirement, wherein, the production costs are also reduced.

### SUMMARY OF THE INVENTION

The object is achieved by a lifting column according to claim 1 and a drive system according to claim 4. Advantageous further developments are included in the dependent claims.

According to an aspect of the invention, a lifting column for a lifting system of a furniture comprises at least two tube sections displaceable with respect to one another like a telescope, a high-voltage direct-current motor, and a transmission, in particular, a spindle nut-system, for transforming a rotational motion into a linear motion. The high voltage direct-current motor and the transmission are arranged in at least one of the at least two tube sections displaceable with respect to one another like a telescope.

The direct-current motor denoted as high-voltage direct-current motor is operated with a direct-current voltage which, contrary to so-called low-voltage direct-current motors which are operated with direct-current voltages of lower than 60 V, is in a region of above 60 V.

The transmission transforms the rotational motion of the high-voltage direct-current motor into a linear motion which is transmitted to the lifting column. Thereby, the at least two tube portions or column portions, which can have arbitrary appropriate cross-sections, displace with respect to one another and, thus, modify a length of the lifting column in order to, for example, perform the height adjustment of a tabletop.

According to an advantageous implementation of the lifting column, the high-voltage direct-current motor is configured to be operated with a rectified local line voltage.

By the utilization of such a high-voltage direct-current motor, it is not necessary to employ a transformer so that its costs and space requirement can be saved. The local line voltages are, for example, the nominal voltage of 230 Volts AC in Europe and the nominal voltage of 120 Volts AC in USA.

In a further advantageous implementation of the lifting column, the high-voltage direct-current motor is designed as a brushless motor.

By the design as a brushless motor, therefore, having an electronic commutation, the jamming source of the wear of the brushes is omitted. Further, due to the omission of the brushes, the noise characteristic and the manufactured size of the motor is reduced with respect to conventional direct-current motors.

According to a further aspect of the invention, a drive system for a lifting system of a furniture comprises at least one lifting column, an operator unit configured to emit signals according to an operation request, at least one power electronics circuit device configured to provide a direct-current voltage, and at least one control electronics circuit device configured to emit signals according to the operation request to the high-voltage direct-current motor.

When providing such a drive system, the power electronics circuit devices can be designed more compact and cheaper since it is not necessary to transform a supply voltage into a voltage required for the motor and, therefore, the space requirement as well as the costs for the drive system can be reduced.

According to an advantageous implementation of the drive system, the drive system comprises an operation signal transmission device configured as a radio link between the operator unit and at least one of the power electronics circuit device and the control electronics circuit device.

By the operation signal transmission to the power electronics circuit device and/or to the control electronics circuit device, depending on where the signals concerning the operation request are processed, as radio link, the operator unit can be attached in arbitrary positions without the necessity to install, as the case may be, disturbing conduits or exposed cables. Further, a subsequent change of the position where the operator unit is attached is easier possible since no cables or conduits have to be installed to other positions.

According to a further advantageous implementation of the drive system, the drive system comprises an operation signal transmission device configured as a cable link between the operator unit and at least one of the power electronics circuit device and the control electronics circuit device.

By the operation signal transmission to the power electronics circuit device and/or to the control electronics circuit device, depending on where the signals concerning the operation request are processed, as cable link, it is not necessary, to fulfill possibly existing regulatory requirements concerning radio links. Further, by a cable link, a reliable and failure-free operation is ensured.

In a further advantageous implementation of the drive system, one single power electronics circuit device is provided, the at least two lifting columns are respectively provided with a control electronics circuit device, and, between the power electronics circuit device and the control electronics circuit devices, a supply line configured to provide a supply voltage for the control electronics circuit device and a communication line configured to provide a signal transmission between the power electronics circuit device and at least one of the control electronics circuit devices are respectively provided.

When providing only one power electronics circuit device, the space requirement for a further power electronics circuit device and the costs therefore can be saved. By the respective provision of one control electronics circuit device for the lifting columns, the lifting columns with their control electronics circuit devices can be tested and calibrated as an assembly in advance so that a facilitated start-up of the drive system is possible. Due to the supply line and the communication line, the power supply and the signal transmission can be performed as failure-free as possible.

In a further advantageous implementation of the drive system, the control electronics circuit device of one of the at least two lifting columns is attached to the lifting column.

Attaching the control electronics circuit device to the lifting column, as the case may be, in an own housing, enables a better handling of the lifting column and the control electronics circuit device. Furthermore, it is not necessary to fasten the control electronics circuit device separately on the furniture which reduces installation efforts of the lifting column to the furniture.

According to a further advantageous implementation of the drive system, the power electronics circuit device is attached to one of the at least two lifting columns.

Due to the attaching of the power electronics circuit device to one of the at least two lifting columns, the otherwise necessary cable link between the power electronics circuit device and the one control electronics circuit device can be omitted since an internal wiring which reduces the manufacturing expense is possible.

In a further advantageous implementation of the drive system, the control line is integrated into the supply line and the signal transmission to the control electronics circuit device is performed via the supply line.

In this implementation, the efforts for a second line can be saved. Thereby, the signal transmission is performed, for example, by modulating the signals on a supply voltage.

In another advantage implementation of the drive system, the at least two lifting columns are respectively provided with one power electronics circuit device and one control electronics circuit device, and the power electronics circuit device and/or the control electronics circuit device are configured to perform a signal transmission via a radio link.

Hereby, a complete modular structure of the drive system is possible since also the power electronics circuit devices can respectively be tested and calibrated in connection with the control electronics circuit device and the motor in advance so that the set-up of the drive system, particularly also by the provision of the radio link, is further facilitated.

According to another advantageous implementation of the drive system, the at least two lifting columns are respectively provided with one power electronics circuit device and one control electronics circuit device, and the power electronics circuit device and/or the control electronics circuit devices are configured to perform a signal transmission via a cable link.

Also here, a complete modular structure of the drive system is possible since, also here, the power electronics circuit devices can respectively be tested and calibrated in connection with the control electronics circuit device and the motor so that the set-up of the drive system is further facilitated and a failure-free communication is ensured.

In a further advantageous implementation of the drive system, at least one control electronics circuit device is arranged at least partially inside at least one of the at least two tube portions displaceable with respect to one another like a telescope.

Such a structure reduces the space requirement outside the lifting column and, further, the control electronics circuit device is better protected from a mechanical damage.

In a further advantageous implementation of the drive system, at least one power electronics circuit device is arranged at least partially inside at least one of the at least two tube portions displaceable with respect to one another like a telescope.

Also such a structure reduces the space requirement outside the lifting column and, further, the power electronics circuit device is better protected from a mechanical damage.

### BRIEF DESCRIPTION OF THE SEVERAL VIEWS OF THE DRAWINGS

Below, the invention is elucidated based on various embodiments referring to the attached drawings.

In particular,

FIG. 1 shows a table having a first embodiment of a drive system having lifting columns from diagonal below;

FIG. 2 shows a table having a second embodiment of the drive system having the lifting columns from diagonal below; and

FIG. 3 shows a table having a third embodiment of the drive system having the lifting columns from diagonal below.

### DESCRIPTION OF SPECIFIC EMBODIMENTS OF THE INVENTION

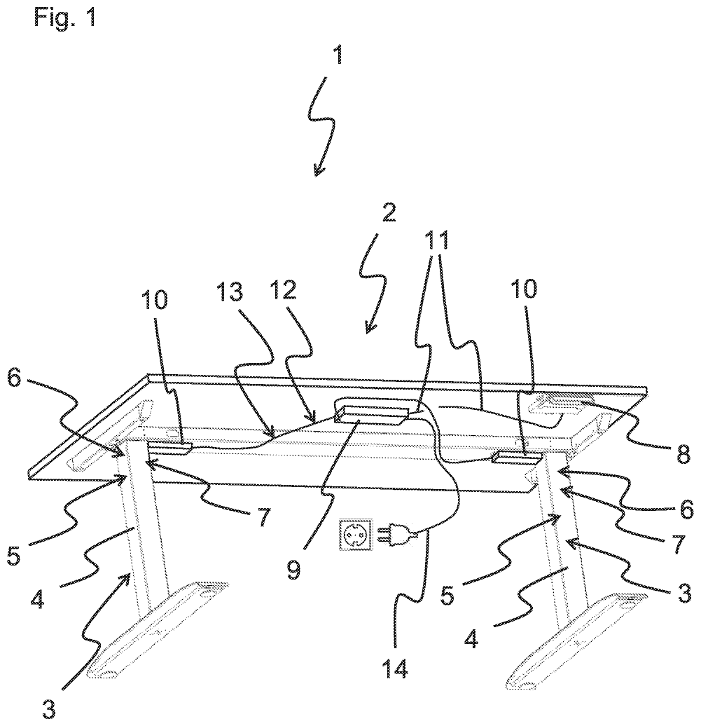

FIG. 1 shows a table as a furniture 1 having a first embodiment of a drive system 2 with lifting columns 3.

The drive system 2 comprises two lifting columns 3. In alternative embodiments, the drive system 1 merely comprises one lifting column 3 or more than two lifting columns 3.

The lifting columns 3 respectively comprise two tube portions 4, 5 displaceable with respect to one another like a telescope. Further, the lifting columns 3 respectively comprise a high-voltage direct-current motor 6. Moreover, the lifting columns 3 respectively comprise a transmission 7 for transforming a rotational motion of the high-voltage direct-current motor 6 into a linear motion. The transmission 7 is designed as a spindle-nut system, however, it can alternatively also be designed as, e.g., a tooth belt drive. By the linear motion, the two tube portions displaceable with respect to one another like a telescope are displaced with respect to one another so that a length of the lifting columns 3 is varied in order to adjust the height of a tabletop of the table. The high-voltage direct-current motor 6 and the transmission 7 are completely arranged inside the two tube portions 4, 5 displaceable with respect to one another like a telescope. In alternative embodiments, the high-voltage direct-current motor 6 and the transmission 7 are not completely arranged inside the tube portions 4, 5 but only at least partially inside one of the tube portions 4, 5.

The high-voltage direct-current motor 6 is configured to be operated with a local line voltage. The local line voltage is, for example, 230 V in Europe and 120 V in USA. In other regions, other line voltages can be possible. The operation with the local line voltage enables operation of the high-voltage direct-current motor 6 without employing a transformer which is necessary with motors operated with a low voltage of, for example, lower than 60 V in order to transform the local line voltage to the low-voltage. The high-voltage direct-current motor 6 is respectively designed for the operation with the local line voltage. In alternative embodiments, a high-voltage direct-current motor 6 is used for line voltages having various nominal voltages.

Further, the high-voltage direct-current motor 6 is designed as a brushless motor. The brushless high-voltage direct-current motor comprises an electronic communication enabling reduction of an operating noise of the high-voltage direct-current motor 6. In alternative embodiments, the high-voltage direct-current motor 6 is not designed as a brushless motor but comprises a mechanical commutator.

Besides the two lifting columns 3, the drive system 2 comprises an operator unit 8. The operator unit 8 is designed is a hand switch, however, it can alternatively also be designed, e.g., as a foot switch. The operator unit 8 emits signals according to an operation request, for example, by pushing a button for an upward or downward motion of the tabletop.

Except from that, the control system 2 comprises a power electronics circuit device 9. The power electronics circuit device 9 provides an appropriate power supply for the high-voltage direct-current motor 6 of the lifting columns 3. Substantially, a DC voltage is provided, wherein the local line voltage usually provided as AC voltage is transformed into a DC voltage without modifying the nominal voltage value. For the various local line voltages, the same power electronics circuit device 9 is used. In alternative embodiments, the power electronics circuit devices 9 are adapted to the respective local line voltage.

In this embodiment, the drive system 2 comprises one single power electronics circuit device 9 mounted centrally to the table frame. In alternative embodiments, the power electronics circuit device 9 is not centrally arranged but it is arranged in another position close to one of the control electronics circuit devices on the table frame or on the tabletop.

Further, the drive system comprises two motor drivers as control electronics circuit devices 10 respectively assigned to one lifting column 3, particularly to the high-voltage direct-current motor 6. The control electronics circuit devices 10 emit signals according to the motion request from the operator unit 8 to the high-voltage direct-current motor 6. Thereby, the direction of rotation of the high-voltage direct-current motor 6 and, as the case may be, a velocity or a course of velocity, as, e.g., a smooth start, are determined.

The control electronics circuit device 10 is provided in a housing on the high-voltage direct-current motor 6 and it is arranged outside the lifting column 3, therefore, the two tube portions 4, 5 displaceable with respect to one another like a telescope. In alternative embodiments, the control electronics circuit device 10 is arranged inside the lifting column 3, or it is arranged in a separate housing which, alternatively, is either arranged inside or partly outside the lifting column 3. Thereby, the control electronics circuit device 10 can be attached to the lifting column 3 or to the table frame. In a further alternative embodiment, only one control electronics circuit device 10 supplying the two lifting columns 3 is provided.

In the present embodiment, the control system 2 comprises an operation signal transmission device 11 in the form of a cable link between the operator unit 8 and the power electronics circuit device 9. Via the operator unit 8, a direction of rotation of the high-voltage direct-current motor 6 as well as, as the case may be, a velocity is predetermined. In alternative embodiments, the operation signal transmission device 11 is designed as a radio link between the operator unit 8 and the power electronics circuit device 6. In further alternative embodiments, the operation signal transmission device 11 is provided between the operator unit 8 and the control electronics circuit device 10.

Moreover, the drive system 2 respectively comprises a supply line 12 between the power electronics circuit device 9 and the control electronics circuit devices 10. The supply line 12 is configured to provide a supply voltage for the control electronics circuit device 10.

Further, a communication line 13 configured to provide a signal transmission between the power electronics circuit device 9 and one of the control electronics circuit devices 10 is respectively provided.

For the sake of clearness, merely the supply line 12 and the communication line 13 between the power electronics circuit device 9 and one of the control electronics circuit devices 10 are provided with a reference sign.

In an alternative embodiment, the communication line 13 is integrated in the supply line 12. Hereby, there is the option that a polarity of single wires is performed according to a desired direction of rotation of the high-voltage direct-current motors 6 and an operation of the high-voltage direct-current motor 6 ensues as long as a voltage is applied. In alternative embodiments, the control signals are modulated on a supply voltage.

The power electronics circuit device 9 is supplied via a mains cable 14.

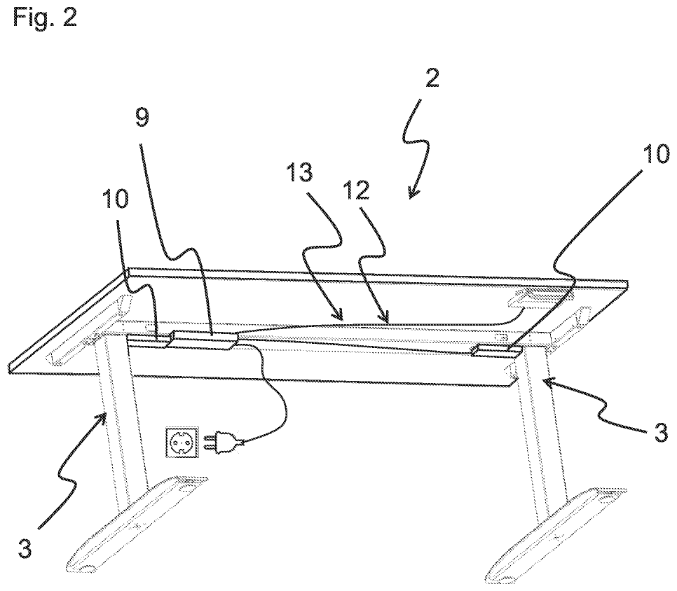

FIG. 2 shows a table having a second embodiment of the drive system 2 having the lifting columns 3.

The second embodiment of the drive system 2 distinguishes from the first embodiments of the drive system 2 in that the power electronics circuit device 9 is not arranged separately from the control electronics circuit devices 10 but that the power electronics circuit device 9 is attached to one of the lifting columns 3. The power electronics circuit device 9 comprises a housing “docked to” one of the two lifting columns 3, particularly to a housing of the control electronics circuit device 10. Thereby, a connection cable between the power electronics circuit device 9 and the one of the lifting columns 3 can be saved.

In an alternative embodiment, the power electronics circuit device 9 can be, at least partially, arranged inside the lifting column 3.

The power electronics circuit device 9 is connected to the other one of the control electronics circuit devices 10 by means of the supply line 12 and the communication line 13, wherein, in alternative embodiments, the communication line 13 can also here be integrated in the supply line 12.

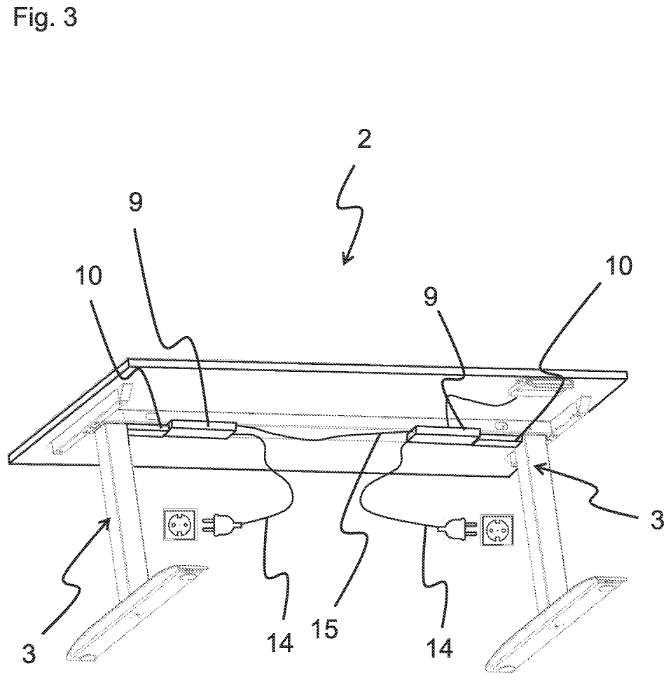

FIG. 3 shows a table having a third embodiment of the drive system 2 having the lifting columns 3.

The third embodiment of the drive system 2 distinguishes from the second embodiment of the drive system 2 in that each of the lifting columns 3 is provided with the control electronics circuit device 10 and the power electronics circuit device 9.

The power electronics circuit devices 9 of the two lifting columns 3 comprise a communication signal transmission device 15 comprising a cable link. In alternative embodiments, also the control electronics circuit devices 10 of the lifting columns 3 can be connected via the communication signal transmission devices 15. In a further alternative embodiment, the communication signal transmission devices 15 does not comprise a cable link but a radio link.

For the supply, the two power electronics circuit devices 9 are respectively provided with a mains cable 14. In an alternative embodiment, only one of the power electronics circuit devices 9 is provided with a mains cable 14. Further power electronics circuit devices 9 are supplied from the one power electronics circuit device 9 by a combination cable consisting of the communication line and the supply line.

In use, the power electronics circuit device 9 provides a suitable power supply for the control electronics circuit devices 10. After an operation of a switching element on the operator unit 8 for a desired motion request, a respective signal is emitted by the operation signal transmission devices 11 via the power electronics circuit device 9 to the control electronics circuit devices 10. Alternatively, the operation signal transmission from the operator unit 8 takes place directly to the control electronics circuit devices 10.

The control electronics circuit devices 10 provide appropriate signals for the high-voltage direct-current motor 6 of the lifting columns 3 in order to execute the motion according to the operation request.

All features illustrated in the description, the subsequent claims and in the drawings, either solitarily as well as in arbitrary combination with one another, can be essential for the invention.

What is claimed is:

1. Lifting column for a lifting system of a furniture, wherein the lifting column comprises:
at least two tube portions displaceable with respect to one another like a telescope,
a high-voltage direct-current motor, and
a transmission for transforming a rotational motion into a linear motion,
wherein
the high-voltage direct-current motor and the transmission are arranged in at least one of the at least two tube portions displaceable with respect to one another like a telescope.

2. Lifting column according to claim 1, wherein
the high-voltage direct-current motor is configured to be operated with a rectified local line voltage.

3. Lifting column according to claim 1, wherein
the high-voltage direct-current motor is designed as a brushless motor.

4. Drive system for a lifting system of a furniture, comprising:
at least one lifting column according to claim 1,
an operator unit configured to emit signals according to an operation request,
at least one power electronics circuit device configured to provide a direct-current voltage, and
at least one control electronics circuit device configured to emit signals according to the operation request to the high-voltage direct-current motor.

5. Drive system according to claim 4, wherein
the drive system comprises an operation signal transmitting device designed as cable link between the operator unit and at least one of the at least one power electronics circuit device and at the least one control electronics circuit device.

6. Drive system according to claim 4, wherein
the drive system comprises an operation signal transmitting device designed as radio link between the operator unit and at least one of the at least one power electronics circuit device and the at least one control electronics circuit device.

7. Drive system according to claim 4, wherein
at least two lifting columns are provided,
one single power electronics circuit device is provided,
the at least two lifting columns are respectively provided with one of the at least one control electronics circuit device, and
a supply line, configured to provide a supply voltage for the control electronics circuit device, between the power electronics circuit device and the control electronics circuit devices, and
a communication line configured to provide a signal transmission between the power electronics circuit device and at least one of the control electronics circuit devices are provided.

8. Drive system according to claim 7, wherein
the control electronics circuit device of one of the at least two lifting columns is attached to the lifting column.

9. Drive system according to claim 8, wherein
the power electronics circuit device is attached to one of the at least two lifting columns.

10. Drive system according to claim 7, wherein
the communication line is integrated in the supply line, and the signal transmission to the control electronics circuit device takes place via the supply line.

11. Drive system according to claim 4, wherein
the at least two lifting columns are respectively provided with a power electronics circuit device and a control electronics circuit device, and
the power electronics circuit devices and/or the control electronics circuit devices are configured to establish a signal transmission therebetween as radio link.

12. Drive system according to claim 4, wherein
the at least two lifting columns are respectively provided with a power electronics circuit device and a control electronics circuit device, and
the power electronics circuit devices and/or the control electronics circuit devices are configured to establish a signal transmission therebetween as cable link.

13. Drive system according to claim 4, wherein
the control electronics circuit device or the control electronics circuit devices is or are at least partially arranged inside at least one of the at least two tube portions displaceable with respect to one another like a telescope.

14. Drive system according to claim 4, wherein
the power electronics circuit device or the power electronics circuit devices is or are arranged at least in partially inside at least one of the at least two tube portions displaceable with respect to one another like a telescope.
